(19) United States
(12) Patent Application Publication
(10) Pub. No.: US 2022/0081328 A1
(43) Pub. Date: Mar. 17, 2022

(54) Method And Device For A Plasma-Induced Water Purification

(71) Applicant: GRAFORCE GMBH, Berlin (DE)

(72) Inventors: Jens Hanke, Berlin (DE); Sascha Knist, Berlin (DE)

(73) Assignee: GRAFORCE GMBH, Berlin (DE)

(21) Appl. No.: 17/291,396

(22) PCT Filed: Nov. 26, 2019
(86) PCT No.: PCT/EP2019/082557

§ 371 Date: May 5, 2021

(30) Foreign Application Priority Data
Nov. 30, 2018 (DE) 10 2018 130 599.0
Jun. 14, 2019 (DE) 10 2019 116 265.3

(51) Int. Cl. C02F 1/461; B01D 53/22; B01D 53/02; C02F 1/46; C02F 1/467

(52) U.S. Cl. CPC C02F 1/46104; B01D 53/225; B01D 53/02; C02F 2101/16; C02F 1/467; C02F 2209/285; C02F 2209/42; C02F 1/4608

(57) ABSTRACT

The invention relates to a method of purifying water contaminated with at least one wastewater substance, wherein the wastewater substance has at least one compound with a binding energy that is lower than the binding energy of a simple hydrogen-oxygen bond. The method comprises the following steps: Providing the contaminated water to a specified fill level in an ungrounded water reservoir within a reaction chamber; applying a high-frequency alternating voltage to precisely one flat cooled plasma electrode arranged at a specified distance above the fill level of the water reservoir at atmospheric pressure, such that a plasma forms in the high-frequency field between the plasma electrode and a surface of the water, the energy input of the plasma being sufficient to dissociate compounds with a binding energy that is lower than or equal to that of a simple hydrogen-oxygen bond; and measuring the concentration of the at least one wastewater substance.

The invention relates to a method and device for plasma-induced water purification.

Water purification, in particular wastewater purification, increasingly presents major challenges for wastewater disposal companies. Wastewater is contaminated with numerous pollutants, with nitrogen compounds being the second most common compounds after carbon compounds. Household wastewater is contaminated, among other things, with nitrogen in the form of ammonium compounds. With an increase in pH value and temperature, they react to form highly toxic ammonia (NH3). Nitrites or nitrates from ground water also contaminate wastewater. Additional contamination occurs as a result of the introduction of hormones or drug residues, for example.

Previous methods of purifying wastewater are extremely complex and require huge amounts of energy. In addition, the ability of sewage treatment plants to purify wastewater is limited. It is in particular difficult to purify residual wastewater, such as exhaust vapor water, press water and centrate water, using the mostly biological processes in the state of the art. Experimental methods, like the use of conventional plasma processes, are not efficient enough for large-scale applications, as described in the paper “Plasma-based water purification: Challenges and prospects for the future” by John E. Foster, in Physics of Plasmas 24, 055501 (2017).

This is where the invention comes in, which provides an efficient method of water purification of even highly contaminated wastewater.

According to a first aspect, the invention relates to a method of purifying wastewater contaminated with at least one wastewater substance, wherein the wastewater substance has at least one compound with a binding energy that is lower than the binding energy of a simple hydrogen-oxygen bond.

The method comprises the following steps:
Providing the contaminated water to a predefined fill level in an ungrounded water reservoir within a reaction chamber.
Applying a high-frequency alternating voltage at atmospheric pressure to exactly one flat cooled plasma electrode arranged at a predefined distance above the fill level of the water reservoir so that a plasma forms in the high-frequency field between the plasma electrode and a surface of the water, the energy input of such plasma being sufficient to cause compounds with a binding energy lower than or equal to that of the simple hydrogen-oxygen bond to be dissociated;
Measuring the concentration of the at least one wastewater substance.

The invention uses so-called plasma electrolysis, i.e. a non-thermal plasma, that initiates processes induced by electron impact. This allows for dissociative electron attachment and dissociative excitation of the water and the wastewater substances contained therein. According to the invention, the dissociation reactions do not occur on two electrodes and/or one membrane surface, like in other methods, but within a plasma-chemical gas and water volume process, which results in much higher efficiencies than with conventional water purification methods. The discharges in this gas and water volume and on the water surface generate free electrons in an energy range (up to 20 eV) that is favorable for the dissociation of compounds with binding energies that are lower than that of the simple hydrogen-oxygen bond. Impacts with the water and gas molecules lead to the formation of numerous excited molecule and atom species. Dissociation takes place via a dual-impact reaction and an extreme charge displacement between the electrode on the one hand, and the water and the contained wastewater substances on the other hand.

The invention further includes the findings that a plurality of wastewater substances contains compounds with a lower binding energy than that of the simple hydrogen-oxygen bond. For example, ammonia has a simple N—H bond, nitrate a simple N—O bond, and hormones and drug residues are often simple carbon compounds. The undesirable wastewater substances can thus be removed from the water by way of dissociation of these compounds without any significant use of the water itself, since the compounds of the wastewater substances dissociate faster than the hydrogen-oxygen bond.

The invention is also based on the findings that, by using high-frequency alternating voltage with only one plasma electrode, plasmas can be ignited at atmospheric pressure, and particularly flat plasmas can be operated at atmospheric pressure, which is not possible when using direct voltage. Operating at atmospheric pressure significantly reduces system and operating costs. The plasma forms in a planar manner between the water surface of the water in the reservoir and the plasma electrode, so that the dissociation of wastewater substances with binding energies lower than that of water also happens in a planar manner and in the entire volume. It is thus possible to also purify a large volume of water.

However, with plasma electrolysis methods known from prior art, for example DE 10 2011 081 915 A1 or the paper “Plasma-based water purification: Challenges and prospects for the future” by John E. Foster, in Physics of Plasmas 24, 055501 (2017), which use two electrodes, only punctiform discharges form between the electrodes at atmospheric pressure. A further advantage of the high-frequency discharges generated within the scope of the invention as compared to forms of discharge conducted with direct voltage is that the electrodes do not have to be in direct contact with the plasma because of the displacement currents occurring in high-frequency plasmas. This prevents impurities from entering the plasma through the electrode material and at the same time ensures a longer service life of the electrode systems.

The invention further includes the findings that, because of the formation of plasma between the plasma electrode and the water reservoir, direct contact between the electrode and the water and thus contamination and corrosion of the electrode can be avoided.

It has been shown that, because of the dissociation process in the plasma, hydrogen and oxygen, which are usually released, do not occur separately in different areas, but mix as a gas with the water vapor and water mist forming in the plasma to form a gas mixture. The plasma process causes an inertization of the hydrogen/oxygen gas mixture, i.e. the mixture is not readily flammable. The two gases do not recombine during dissociation in the reaction chamber. This means that hydrogen and oxygen as well as other gases can be passed through a common exhaust pipe and separated by means of membranes.

The method according to the invention can thus be used to purify larger quantities of contaminated water at a lower cost; in addition, valuable gaseous components of the at least one wastewater substance, such as hydrogen, can be made available for other applications.

In the context of this application, exactly one flat plasma electrode is also understood to mean, aside from the preferred variant of a one-piece plasma electrode, a plasma electrode arrangement made up of several individual electrodes that are arranged side by side at a predefined distance above the water reservoir and that make up the exactly one plasma electrode.

Advantageous embodiments of the method according to the invention will be described below. The additional features of the exemplary embodiments can be combined to form further embodiments, unless the description expressly characterizes them as alternatives to each other.

In a preferred embodiment, a high-frequency alternating voltage is applied to the exactly one plasma electrode at atmospheric pressure in such a way that a contracted plasma forms. The term contracted plasma means that one or several large discharges occur which also exhibit a narrow range of mobility across the water surface. This differentiates it from filamented plasma in which a plurality of small discharges with a comparatively wide range of mobility across the water surface occurs. In the context of the invention, it has been found that purification of contaminated water is particularly efficient if the generated plasma is a contracted plasma.

A contracted plasma is preferably generated by connecting a direct voltage, preferably 100 V to 3000 V and 0.01 mA bis 250 mA, to the contaminated water in the water reservoir in addition to the high-frequency alternating voltage. In this case, the negative pole of a direct voltage source is connected to the water reservoir. It has been found that a direct voltage connected in this way works similarly to an offset voltage and results in a contracted plasma and improved purification capacity. A small direct current occurs in the contaminated water and only flows through the plasma of the electrode.

Alternatively, or additionally, a contracted mode of the plasma is achieved in which the water temperature is kept below 25° C. To this end, pre-heated or pre-cooled water can be added to the reservoir, for example. The water temperature can be changed outside the reservoir by way of heat exchangers or cooling units, for example. Alternatively, or additionally, the temperature of the water reservoir can be changed by means of a cooling device directly on the water reservoir, for example.

In a preferred embodiment, the method further comprises:
Comparing the measured concentration with a stored threshold value; the following occurs if the measured concentration is below or equal to the stored threshold value:
the application is stopped, or
the treated water is drained and replaced with contaminated water.

Alternatively, the application is carried out over a predefined period of time, after which the concentration is measured and compared. The comparisons can be used to ensure that the treated water has been sufficiently purified for the respective subsequent use.

In one embodiment, the concentration is measured continuously, which means that permanent monitoring is possible. Alternatively, the concentration can also be measured at predefined time intervals.

The stored threshold value is preferably a statutory limit or below a statutory limit. To ensure that the treated water can be used for other applications, such as drinking water, the threshold value for organic carbon in drinking water is 150 mg/l and for ammonia 0.5 mg/l, for example. The threshold value for the discharge of organic carbon into the wastewater for heavy polluters is 2000 mg/l.

Polluted water includes, for example, municipal or industrial wastewater, wood gas condensation water, greasy water, cellulose water, exhaust vapor water, centrate water, press water, process water from sewage sludge treatment, landfill leachate, washing water, for example from flue gas cleaning, oily water, mining wastewater, wastewater from oil production (for example from fracking, from drilling platforms), ammonia water, slurry (e.g. pig, cattle or poultry slurry), liquid digestate, or process water obtained from these.

In one embodiment, the provision of contaminated water comprises the concentrating of the at least one wastewater substance in the contaminated water. This way the wastewater substance is available at a correspondingly high concentration for subsequent purification which, according to the invention, not only serves the production of purified water but also the provision of valuable components of the wastewater substance for later use. This embodiment is based on the findings that increasing the concentration of the wastewater substance in the purification processes according to the invention, which initially seems counterproductive, results in an increase in the recovery of valuable gaseous components of the wastewater substance and does not negatively affect the purification results. Furthermore, it turned out that when highly concentrating wastewater substances, such as ammonia or hydrocarbon chains, it is primarily the wastewater substances that are split, while the water molecule is rarely split, and in borderline cases water splitting completely stops.

Concentrating can be achieved e.g. by way of dehydration, membrane distillation or precipitation, for example magnesium ammonium phosphate precipitation (MAP precipitation), or by using an ion exchanger.

Wastewater is understood to mean, for example, municipal or industrial wastewater, wood gas condensation water, greasy water, cellulose water, exhaust vapor water, centrate water, press water, washing water, for example from flue gas cleaning, oily water, mining wastewater, wastewater from oil production (for example from franking, from drilling platforms), ammonia water, process water from sewage sludge treatment, landfill leachate, slurry (e.g. pig, cattle or poultry slurry), liquid digestate, or process water obtained from these.

Polluted water is thus understood to mean e.g. the types of wastewater outlined above in the way they occur as well as polluted water obtained from them by way of concentration, which can have significantly higher concentrations of wastewater substances than conventional wastewater.

Concentrating is preferably performed with a jet loop reactor. A jet loop reactor consists of a powerful inflow device (jet) for the liquid to be concentrated, and a device for circulating the inflowing medium, in its simplest design, the jet loop reactor features an outer tube and an inner tube arranged inside the outer tube. The liquid is moved to the bottom of the reactor in a propulsion jet and circulated within the reactor. A return in the inner tube and a return between the inner tube and the outer tube are both possible. External circulation and return via pumps is also possible. Added gas, in particular air, can be added both in the upper and in the lower part of the reactor. In further embodiments, an additional energy source is used to increase the internal circulation of the chosen reaction medium. Jet loop reactors are advantageous compared to conventional stripping systems in that no fillers or intermediate plates are required to increase the contact surface between air and liquid, the required air intake is lower, and they have a lower construction height.

It has been shown that jet loop reactors are particularly suitable for concentrating ammonia since e.g. the NH₃ diffusion rate is significantly increased. However, it is also possible to use a conventional stripping method. In a further embodiment, concentrating thus comprises the stripping of at least one wastewater substance from wastewater into a carrier gas and regenerating the at least one wastewater substance from the loaded carrier gas into contaminated water, in particular in a scrubber column.

Stripping is a physical separation method in which substances are converted from a liquid phase into a gas phase by way of desorption processes (using Henry's law). To this end, the liquid phase is put into contact with a gas using the counterflow principle. To achieve the most efficient stripping, the substance to be converted must be available in the liquid phase in a liquid as much as possible; for example, for ammonia stripping, the ammonium present in the liquid must be available almost completely as ammonia. This can be achieved by adjusting the temperature and pH value. Depending on the temperature and pressure, the stripping gas car only be loaded with a certain ammonia concentration. The equilibrium concentration in the gas is proportional to the concentration of the liquid phase in the liquid. Stripping can happen as follows, for example: the liquid (which contains the liquid phase of the wastewater substance) is fed into a column from above and channeled downwards into the column sump via a distribution system. This is where the clean water is collected. A carrier gas is introduced into the column from below and moved to the liquid in a countercurrent flow. Air (air stripping) or steam (steam stripping) can be used as the medium, for example. A largest possible mass transfer area facilitates the transition from liquid to the gaseous phase. Different packing material, usually made of plastic, is used for this purpose. The utilized material is particularly resistant to dirt and deposits caused by precipitation.

Stripping by introducing steam or air is preferred. Steam stripping in ammonia stripping requires a greater amount of thermal energy and NaOH as an additive to push the pH value into the NH₃ range; 90% of the NH₄ load can be extracted this way, for example. In most applications, process waste heat from other areas is available anyway and can be used here.

With air stripping, in particular ammonia stripping, the waste heat (e.g. 70 to 75 degrees)—e.g. from a combined heat and power unit (CHP)—is sufficient to remove 75% of the NH₄ load without the addition of alkali in many cases. The remaining 25% of NH₄ can be spread on fields over a longer period of time as a light fertilizer, for example.

In air and steam stripping, for example, regeneration can take place in a scrubber column with acid as the scrubbing solution. In ammonia stripping, for example, a crystal slurry is produced as the contaminated water, which is then discharged from the scrubber column.

Water is preferably used as the scrubbing solution in a scrubber column. This way it is possible to produce contaminated water with a high concentration of the wastewater substance without further contaminating the water by adding an acid, for example In addition, after purification, the purified water can be circulated and thus reused as a scrubbing solution after purification; this means that it serves as a transport medium for the at least one wastewater substance.

It is also advantageous if the liquid is filtered prior to stripping to avoid coarse contaminants.

The wastewater substance is preferably ammonia or ammonium. Stripping would then be ammonia stripping, or the ammonia is concentrated with a jet loop reactor, in ammonia stripping, it is particularly advantageous to use ammonium compounds dissolved in water as the scrubbing solution during regeneration.

Moreover, in particular in ammonia stripping or the concentrating of ammonia in a jet loop reactor, the dissociation equilibrium can be shifted in the direction of ammonia by increasing the pH value in a pretreatment. This can be achieved by adding an alkali, usually sodium hydroxide (NaOH) or calcium hydroxide (Ca(OH)2). The addition of an alkali is not necessary in ammonia stripping at a temperature range of 75 bis 80° C. in the case of liquids with a high CO2 content, for example the sludge liquor of a biogas plant, that have a significant buffer effect, an additional pretreatment option prior to ammonia stripping is to decarbonize the liquid by way of upstream CO₂ stripping or using a jet loop reactor in one process step and to increase the pH value to 8.0-8.5, thereby also reducing the use of alkalis.

In one embodiment of the method, the provision of contaminated water comprises the collection of the contaminated water—in particular if the contaminated water was produced by way of concentrating, in particular stripping—in at least one transport container, transporting it in this transport container, and the contaminated water then being provided from the transport container. For the purposes of this invention, wastewater occurs in sewage treatment plants, on landfills, or in biogas plants. However, the components of the wastewater substance, such as hydrogen, released during purification are not necessarily needed at these locations but, for example in the case of hydrogen, at filling stations, combined heat and power plants, or the like. It is especially easy to transport contaminated water that has been concentrated without any strict safety measures, so that it is possible with this embodiment of the method to perform the actual purification and thus the extraction of valuable components, such as hydrogen, directly at a filling station and to make the components available for further use there, without the components having to be transported in their pure forms, especially as a gas, which is associated with considerably bigger problems than the transporting of liquids.

The contaminated water thus also serves as a hydrogen storage and car be stored over long periods of time without loss, transported with high energy density, and distributed. Because of the plasma process, the hydrogen can be released from the contaminated water and the contaminated water purified in a very energy efficient manner at the location and time the energy is required. If nitrogen is also released in the process, it can subsequently be used as an industrial gas, for example.

The at least one wastewater substance is preferably selected from the group of nitrogen compounds, in particular the nitrogen-hydrogen bonds, carbon compounds, boron, oxygen, phosphorus, sulfur, or chlorine compounds, Hormones or drug residues can also be wastewater substances in the sense of this application, provided they contain at least one compound with a lower binding energy than that of the simple hydrogen-oxygen bond. With the water purification according to the invention, it is thus possible to remove a wide range of wastewater substances without having to use a specific method for each substance.

It has been shown that in particular pain relievers, such as diclofenac, the antiepileptic drugs carbamazepine and gabapentin, beta blockers as well as antibiotics are very easy to split and thus to remove from the wastewater using the method according to the invention.

The following table provides an overview of common compounds that occur in wastewater substances and that have a lower binding energy, or bond enthalpy, than the simple hydrogen-oxygen bond.

TABLE 1
Bond enthalpy ΔH in kJ/mol of different compounds

| with hydrogen | | with carbon | | with oxygen | | same element | |
|---|---|---|---|---|---|---|---|
| bond | ΔH | bond | ΔH | bond | ΔH | bond | ΔH |
| H—H | 436 | C—C | 348 | O—N | 201 | H—H | 436 |
| H—C | 413 | C—H | 413 | O—P | 335 | N—N | 163 |
| H—O | 463 | C—O | 358 | O—F | 193 | N═N | 418 |
| H—N | 391 | C—N | 305 | O—Cl | 208 | O—O | 146 |
| H—P | 322 | C—P | 264 | O—Br | 234 | P—P | 172 |
| H—S | 367 | C—S | 272 | O—I | 234 | S—S | 255 |
| H—Cl | 431 | C—Cl | 339 | | | | |
| H—Br | 366 | C—Br | 285 | | | | |
| H—I | 298 | C—I | 218 | | | | |

As shown in Table 1, a large number of hydrogen compounds has a lower binding energy than that of the hydrogen-oxygen bond, which means that, advantageously, hydrogen is also released to a greater extent as a byproduct of the water purification. Advantageously, the wastewater substance comprises ammonium NH4+ or ammonia NH3. The dissociation of these bonds results in a particularly high yield of hydrogen and nitrogen, which are preferred byproducts of water purification according to the invention. It has been shown in the context of the invention that, because of the dissociation of hydrogen-nitrogen bonds with simple hydrogen-nitrogen bond, facilitated by the lower binding energy as compared to the dissociation of water, these cannot only be removed from the contaminated water, but that it also results in a higher hydrogen yield than with the dissociation of purified water. It is thus possible to also inexpensively produce hydrogen as a byproduct using the method according to the invention. If the wastewater substance contains ammonium or ammonia, it has been proven to be particularly advantageous if the distance between the plasma electrode and the fill level of the contaminated water is not set too small. It is particularly advantageous in this case if the distance is in the range between 1.5 and 2 cm.

Preferably, a high-frequency generator with a predefined output impedance is used to apply the high-frequency alternating voltage to the plasma electrode; this high-frequency generator is connected to the plasma electrode via a matching network for impedance matching of an impedance of the plasma and the output impedance of the high-frequency generator.

A plasma has a complex impedance that depends on numerous external parameters (e.g. on the occurring plasma-chemical process), is temporally variable and thus generally different from the output impedance of the generator. The impedance of the plasma is particularly dependent upon the distance of the plasma electrode from the water surface, the water composition, the temperature in the reaction chamber, and the atmosphere in the reaction chamber. Therefore a so-called matching network (or matchbox) is advantageously used as a link between the high-frequency generator and the gas discharge that aligns the ohmic and capacitive components of the plasma with the impedance specified by the generator, which means it adjusts the variable load of the plasma to the internal resistance of the generator and thus minimizes a reflection of energy from the system.

This can be implemented, for example, by measuring the intensity and power of an outgoing and returning wave to the high-frequency generator, and stabilizing the generator power depending on the power of the outgoing wave, and minimizing the power of the returning wave depending on a conductivity or the pH value of the contaminated water via the matching network. The capacitor and coil are adjusted in accordance with the conductivity or the pH value of the water, which changes as the purification progresses.

The high-frequency alternating voltage preferably has a frequency in the range of 1 to 40 MHz, particularly in the range of 10 to 20 MHz, and/or power in the range of 100 W to 40 kW, preferably in the range of 1 to 5 kW, is applied to the plasma electrode. The method produces a high yield of purified water with optimized energy input in these ranges.

In a further embodiment, the method also comprises the following steps:
Collecting gases generated as a result of the dissociation in a common exhaust pipe;
Separating the generated gases by way of a multi-stage membrane process and/or by using selective adsorption methods.

Gases like hydrogen, oxygen, nitrogen, CO2 or methane are desirable potential byproducts in water purification. With this embodiment, it is easy to separate the generated gases and thus also to separately collect the desirable byproducts.

In a selective adsorption method, for example, the hydrogen-oxygen mixture is passed across a reservoir which has at least one adsorber that will preferably bind the oxygen by way of adsorption. Only hydrogen is thus released initially. The adsorbed oxygen can then be released from the adsorber in a further step, for example by way of pressurization or thermal release.

Ceramic materials with a large surface area and high oxygen adsorption capacity, in particular so-called molecular sieves, are preferably used as adsorbers. Aside from zeolites, i.e. cristalline aluminosilicates, these can also be carbon molecular sieves. Silica gel or activated aluminum oxide can preferably be used.

Contaminated water is preferably added to the water reservoir continuously. In addition, the fill level and thus the distance from the plasma electrode can be kept almost constant. This reduces the adjustment effort involved in plasma generation, for example by way of a matching network.

In an advantageous embodiment, the plasma electrode is coated with a dielectric and the plasma is designed as a barrier discharge. Dielectrically restricted discharges, also referred to as dielectric barrier discharges (DBDS), occur when two electrodes, in this case the plasma electrode and the water, which itself has a certain impedance but not an electrode or grounding, are separated by at least one isolator, for example a dielectric. The barrier discharge usually consists of short-lived filamentary micro-discharges with a low discharge current. It limits the electrical charge transported by the discharge, i.e. it limits the current flow in the system and distributes the discharge across the electrode surface. The yield of purified water can be positively influenced by maximizing the area of micro-discharges at a certain frequency, temperature and impedance. Having the dielectric on the plasma electrode prevents the charge carriers from recombining with the electrode and increases the dissociation efficiency.

A ceramic material, in particular a material that contains aluminum oxide or titanium oxide, is preferably used as a dielectric.

In one embodiment, air, Ar, He, N or Ne is used as the atmosphere in the reaction chamber as part of the starting process, i.e, when the plasma is ignited.

The water in the water reservoir preferably has a temperature in the range of 3 to 99° C.; the water is liquid in this temperature range. It is further preferred to use a range of 3 to 25° C., in particular 5 to 250° C., in which the efficiencies are particularly high, for wastewater purification.

In one embodiment, the plasma electrode is cooled to a temperature in the range of 60 to 70° C.

In a further development, the contaminated water contains at least one carbon compound as a wastewater substance. In this case, it is advantageous if the method also includes the following steps:
Collecting gases generated as a result of the dissociation in a common exhaust pipe;
Measuring a methane concentration in the common exhaust pipe;
Maintaining the application until a minimum methane concentration in the exhaust pipe is reached.

If carbon compounds in the wastewater substances are dissociated as part of the plasma process, carbon is released which initially reacts to form carbon monoxide or carbon dioxide, for example with oxygen from the latent water dissociation or other dissociation reactions. If a sufficient amount of carbon monoxide or carbon dioxide is available, a reaction, supported by the plasma, with the nitrogen that is also available at least from the latent water dissociation takes place to form methane. A hydrogen-nitrogen bond is preferably present as a wastewater substance at the same time so that larger amounts of hydrogen are released for methanation. Methane is a desired byproduct of water purification and can be used as fuel either by itself or together with the hydrogen that is also produced.

Advantageously, an oxygen compound is present in the water as a further wastewater substance.

Various parameters promote methanation while at the same time maintaining the purification efficiency of the process. Depending on the focus, application can be adjusted according to the production of the desired methane quantities or faster purification.

To promote methanation, the plasma electrode is preferably cooled to a temperature in the range of 80 to 90° C. It is also advantageous if a catalyst is used for the methanation of carbon monoxide and/or carbon dioxide.

Different catalysts and catalyst systems can be used for the methanation of CO₂ and CO, in particular also combinations of active components, substrates and promoters. Transition metals preferably serve as the active component, wherein particularly nickel, ruthenium, but also cobalt or iron make good catalysts. Ni/Al₂O₃ and other Ni systems are particularly preferred for CO methanation, as well as Ni, Ru, Co on different substrates, for example Al₂O₃, SiO₂, TiO₂, ZrO₂ or CeO₂, or rice husk ash, for CO₂ methanation.

In this case, methanation occurs, for example, with the support of a catalyst that can be implemented as a pure (e.g. nickel) plasma electrode, as a coating of the plasma electrode, or as a fill or foam in a catalyst chamber within the plasma electrode or in the exhaust pipe. In one embodiment, the coating is a pure catalyst layer, for example Ni, on the plasma electrode as a nickel electrode mesh, or the catalyst is an additive in a dielectric coating of the plasma electrode, for example an Al₂O₃Ni coating. Ruthenium can also be used as a catalyst, for example as a 5% admixture in an Al₂O₃ coating of the electrode. Alternatively, the catalyst is implemented as a catalyst powder/granulate or open-cell foam in a chamber of the plasma electrode. This chamber is then designed as a flow-through chamber, and the plasma electrode has corresponding openings. Finally, the catalyst can also be arranged in a chamber or on the exhaust pipe as a powder, granulate or open-cell foam.

To boost methanation, CO₂ and/or CO can be used as the atmosphere in the reaction chamber as part of a start-up process so that CO₂ and/or CO is available for methanation from the beginning, and the start-up phase of methanation is thus shortened.

It is also advantageous if methane is subsequently separated by way of at least one additional membrane or a selective adsorption method, so that pure methane is available for further use or can be mixed with hydrogen at a predefined ratio in accordance with the requirements for a methane-hydrogen fuel. ZSM-5, Zeolite Socony Mobil-5, a synthetic high-silica aluminosilicate zeolite, is used here as an adsorber, for example.

According to a further development, by setting a temperature in the range of lower than 70 degrees and using a plasma electrode made of aluminum or steel and/or with an Al2O3 coating from the carbon dioxide and hydrogen in the reaction chamber generated as a result of the dissociation of carbon compounds in the contaminated water, the formation of methane is largely suppressed so that discharged carbon dioxide and hydrogen can be converted to carbon monoxide in an inverse CO-shift compression with the addition of electricity and heat. The resulting carbon monoxide is then introduced to a Fischer-Tropsch synthesis together with additional hydrogen from the purification process and subsequently converted, again together with additional hydrogen from the purification process, into gasoline, kerosene or diesel by way of hydrocracking, isomerization or distillation. Alternatively, it is also possible to use carbon monoxide produced directly by the purification process.

According to a second aspect, the invention relates to a device for the purification of water contaminated with at least one wastewater substance, comprising:

In a reaction chamber
an ungrounded water reservoir;
precisely one flat cooled plasma electrode that is arranged at a predefined distance above the fill level of the water reservoir;
a sensor for measuring the concentration of the wastewater substance;

and outside of the reaction chamber
a high-frequency generator with a predefined output impedance that is connected to the plasma electrode via a matching network for impedance matching of an impedance of the plasma forming at the plasma electrode and of the output impedance of the high-frequency generator.

Advantageously, a so-called matching network (or matchbox) is used as a link between the high-frequency generator and the plasma, which aligns the ohmic and capacitive components of the plasma with the output impedance specified by the generator. The impedance of the plasma is particularly dependent upon the distance of the plasma electrode from the water surface, the water composition, the quality of the housing around the reaction chamber, the temperature in the reaction chamber, and the atmosphere in the reaction chamber.

Apart from that, the device shares the advantages and embodiments of the method according to the first aspect of the invention.

In one embodiment, the high-frequency generator comprises a measuring device for measuring the intensity and power of an outgoing and returning wave. It is particularly preferred if the measuring device comprises a directional coupler and two detectors in the high-frequency generator.

The output impedance of the high-frequency generator is preferably 50 ohms and/or the output power of the high-frequency generator is between 100 W and 40 kW. It has been shown that, in particular with this output impedance, a plasma forms particularly reliably while at the same time providing good purification capacity.

Advantageously, the matching network comprises at least one motor-controlled capacitor and at least one variable coil. Together, these make up an electrical oscillating circuit which enables the impedance matching to react continuously, also to fluctuating loads from the plasma. In a further embodiment, alignment of the capacitors and coils occurs automatically via a reflection and standing wave control loop method.

A common exhaust pipe for the resulting gases is preferably arranged on the reaction chamber In order to extract different gases, it is particularly advantageous if a plurality of membranes and/or adsorbers is arranged in the common exhaust pipe or at one end of the common exhaust pipe for separating the resulting gases.

In one embodiment, the exhaust pipe is arranged in the plasma electrode, i.e. the plasma electrode comprises at least one opening towards the reaction chamber and at least part of the exhaust pipe.

Polymer membranes are preferably used, for example, for separating hydrogen and oxygen. Alternatively, a reservoir is arranged in the common exhaust pipe or at one end of the common exhaust pipe, which reservoir has at least one adsorber, for example in the form of a fill or open-cell foam. The adsorber for separating hydrogen and oxygen is advantageously designed in such a way that oxygen is bound to it preferably by way of adsorption. However, combinations of membranes and adsorbers can also be used for the different gases that form. Polymer membranes separate CO2 and CH4 and N2 well; however, zeolites, like ZSM-5, a synthetic high-silica aluminosilicate zeolite, can also be used here.

In a further development, a device for dissolving the adsorbed oxygen is provided on the reservoir. For example, this device can be designed in the form of a heater for thermally dissolving the oxygen, or in the form of a vacuum pump for applying negative pressure. However, the reservoir car also have a sealable opening via which the loaded adsorber can be exchanged for an unloaded adsorber after adsorption.

Ceramic materials with a large surface area and high oxygen adsorption capacity, in particular so-called molecular sieves, are preferably used as adsorbers. Aside from zeolites, i.e. cristalline aluminosilicates, these can also be carbon molecular sieves. Silica gel or activated aluminum oxide can preferably be used. In one embodiment, the plasma electrode has a metal, in particular aluminum, which is preferred because of good conductivity at a relatively low cost.

Advantageously, the plasma electrode is coated with a dielectric, in particular comprising aluminum oxide and/or nickel and/or titanium dioxide. This enables the formation of plasma via a barrier discharge. The dielectric preferably has a layer thickness of 200 to 1000 μm.

The device preferably has at least one inlet for at least one gas into the reaction chamber, in particular for air, Ar, He, Ne, N, CO and/or CO₂.

In one embodiment, a plasma electrode arrangement made up of several individual electrodes arranged next to each other at a predefined distance above the water reservoir makes up the exactly one plasma electrode. With this embodiment, the energy input can be optimized and, at the same time, the production and cooling effort can be improved as compared to a monoblock plasma electrode with the same surface area.

In this embodiment, each individual electrode is connected to the high-frequency generator. Alternatively, several high-frequency generators with a predefined output impedance can be used; in this case, each of these generators is connected to an individual electrode or a group of individual electrodes via a respective matching network for impedance matching of an impedance of a plasma forming at the respective individual electrode or the group of individual electrodes, and to the output impedance of the high-frequency generator.

The water reservoir preferably has an inlet and at least one outlet. It is further preferred that the sensor is arranged in the area of the at least one outlet. The water reservoir thus enables a continuous process in which contaminated water is continuously added and purified water removed through the outlet. Removal can be made dependent upon the measurement result of the sensor, i.e. on the actual degree of purification. To this end, a valve can be arranged at the outlet that only opens if the measurement result fails below the threshold value in the area of the sensor.

In a further embodiment, the water reservoir comprises a fill-level control that is designed to keep the fill level of the water nearly constant, or an overflow. The fill level is preferably in the range of 1.5 to 10 cm.

To achieve the most complete purification of the water volume in the water reservoir, the distance between the plasma electrode and each wall of the reaction chamber is in the range of 1 to 2 cm. A surface area of The plasma electrode between 15 cm² and 450 cm² is advantageous for treating large amounts of water.

It is further preferred that the predefined distance between the plasma electrode and the fill level of the water reservoir is in a range of 0.2 to 2 cm, more preferably in the range of 1 to 2 cm.

If the extraction of methane is an absolute priority, the step of measuring the concentration of the at least one wastewater substance can also be omitted. According to a third aspect, the invention thus relates to a method of extracting methane from water contaminated with at least one wastewater substance, wherein the wastewater substance contains at least one carbon compound with a binding energy that is lower than the binding energy of a simple hydrogen-oxygen bond.

The method according to the third aspect comprises the following steps:
Providing the contaminated water to a predefined fill level in an ungrounded water reservoir within a reaction chamber.
Applying a high-frequency alternating voltage at atmospheric pressure to precisely one flat cooled plasma electrode arranged at a predefined distance above the fill level of the water reservoir so that a plasma forms in the high-frequency field between the plasma electrode and a surface of the water, the energy input of such plasma being sufficient to cause compounds with a binding energy lower than or equal to that of the simple hydrogen-oxygen bond to be dissociated;
Collecting gases produced as a result of the dissociation in a common exhaust pipe;
Measuring a methane concentration in the common exhaust pipe;
Maintaining the application until a minimum methane concentration in the exhaust pipe is reached.

This aspect of the invention is based on the findings that carbon and hydrogen released from wastewater substances are converted into methane in the plasma process. If carbon compounds in the wastewater substances are dissociated in the course of the plasma process, carbon and oxygen are released that initially react to form carbon monoxide or carbon dioxide, for example with oxygen from the latently occurring water dissociation or other dissociation reactions. Once a sufficient amount of carbon monoxide and/or carbon dioxide is available, for example at least 10% carbon dioxide, a reaction takes place, supported by the plasma, with the hydrogen also available at least from the latent water dissociation to form methane. In this case, hydrogen should be present at a concentration of at least 30%. Methane is thus not merely a desired byproduct of water purification; this aspect of the invention rather focuses on the cost-effective production of methane that can subsequently be used as fuel, either by itself or together with the hydrogen that is also produced. This aspect of the invention thus constitutes a comparatively inexpensive and energy-efficient as well as cost-effective method of producing methane.

A hydrogen-nitrogen bond is preferably also present as a wastewater substance, so that larger amounts of hydrogen are released for methanation, thereby further improving energy efficiency.

To promote methanation, the plasma electrode is preferably cooled to a temperature in the range of 80 to 90° C. It is also advantageous if a catalyst is used for the methanation of carbon monoxide and/or carbon dioxide.

Different catalysts and catalyst systems can be used for the methanation of CO₂ and CO, in particular also combinations of active components, substrates and promoters. Transition metals preferably serve as active components; particularly nickel and ruthenium, but also cobalt or iron make good catalysts. Ni/Al₂O₃ and other Ni systems are particularly preferred for CO methanation, as well as Ni, Ru, Co on different substrates, for example Al₂O₃, SiO₂, TiO₂, ZrO₂ or CeO₂, or rice husk ash, for CO₂ methanation.

In this case, for example, methanation takes place and is supported by a catalyst that can be implemented as a pure (e.g. nickel) plasma electrode, as a coating of the plasma electrode, as a nickel electrode mesh, or as a fill or foam in a catalyst chamber within the plasma electrode or in the exhaust pipe. In one embodiment, the coating is a pure catalyst layer, for example Ni, on the plasma electrode, or the catalyst is an additive in a dielectric coating of the plasma electrode, for example an Al2O3Ni coating. Alternatively, the catalyst is implemented as a catalyst powder/granulate or open-cell foam in a chamber of the plasma electrode. In this case, the chamber is designed as a flow-through chamber, and the plasma electrode has corresponding openings. Finally, the catalyst can also be arranged in a chamber in or on the exhaust pipe as a powder, granulate or open-cell foam.

To boost methanation, CO₂ and/or CO can be used as the atmosphere in the reaction chamber as part of a start-up process so that CO₂ and/or CO is available for methanation from the beginning, and the start-up phase of methanation is thus shortened.

It is also advantageous if methane is subsequently separated by way of at least one additional membrane or a selective adsorption method, so that pure methane is available for further use or can be mixed with hydrogen at a predefined ratio in accordance with the requirements for a methane-hydrogen fuel. ZSM-5, Zeolite Socony Mobil-5, a synthetic high-silica aluminosilicate zeolite, is used as an adsorber, for example.

Apart from that, the method according to the third aspect of the invention shares the advantages and embodiments of the method according to the first aspect of the invention.

According to a fourth aspect, the invention relates to a device for the production of methane from water contaminated with at least one wastewater substance, comprising:

In a reaction chamber
an ungrounded water reservoir;
precisely one flat cooled plasma electrode that is arranged at a predefined distance above the fill level of the water reservoir;

and outside of the reaction chamber
a high-frequency generator with a predefined output impedance that is connected to the plasma electrode via a matching network for impedance matching of an impedance of the plasma forming at the plasma electrode and of the output impedance of the high-frequency generator; as well as
a common exhaust pipe on the reaction chamber and a sensor arranged therein or at one end of the exhaust pipe for measuring the methane concentration.

In one embodiment, the exhaust pipe is arranged in the plasma electrode, i.e. the plasma electrode comprises at least one opening towards the reaction chamber and at least part of the exhaust pipe.

Preferably, a catalyst is used that can be implemented as a pure (e.g. nickel) plasma electrode, as a coating of the plasma electrode, as a nickel electrode mesh, or as a fill or foam in a catalyst chamber within the plasma electrode or in the exhaust pipe. In one embodiment, the coating is a pure catalyst layer, for example Ni, on the plasma electrode, or the catalyst is an additive in a dielectric coating of the plasma electrode, for example an Al2O3Ni coating. Alternatively, the catalyst is implemented as a catalyst powder/granulate or open-cell foam in a chamber of the plasma electrode. This chamber is designed as a flow-through chamber, and the plasma electrode has corresponding openings. Finally, the catalyst can also be arranged in a chamber in or on the exhaust pipe as a powder, granulate or open-cell foam.

Apart from that, the device according to the fourth aspect of the invention shares the advantages and embodiments of the method according to the third aspect of the invention.

Examples of embodiments are also indicated in the claims.

In the following, further exemplary embodiments of the device and method will be described based on the drawings. The drawings show the following:

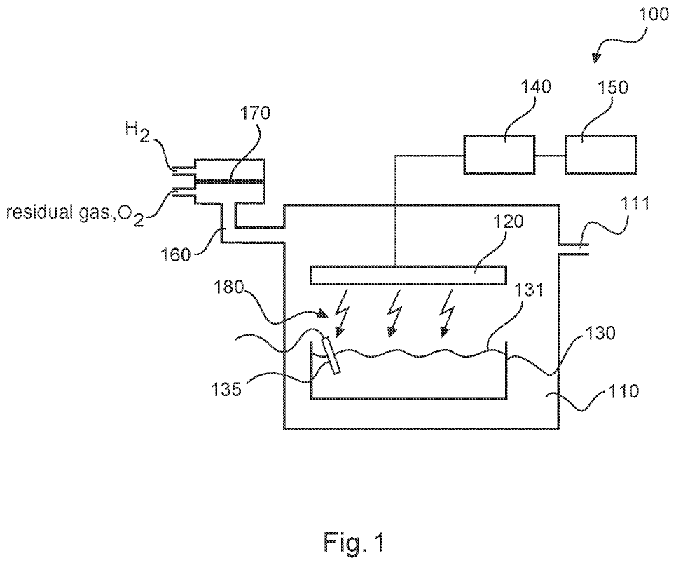

FIG. 1 shows a schematic diagram of an exemplary embodiment of a device for plasma-induced water purification according to the second aspect of the invention;

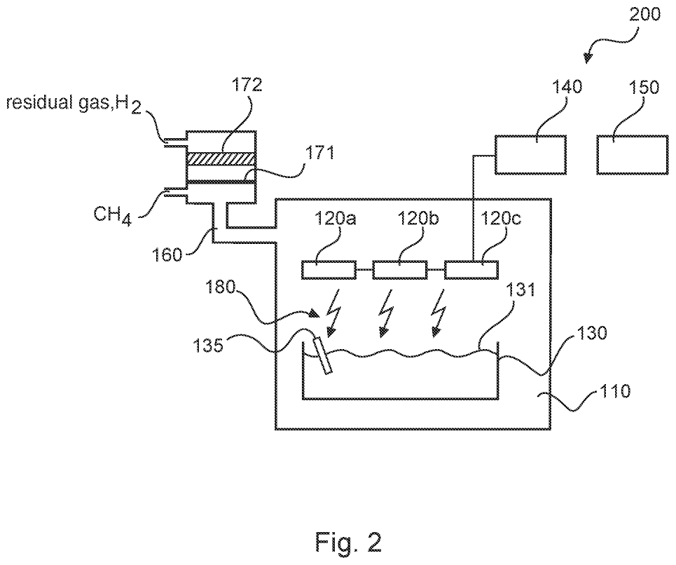

FIG. 2 shows a schematic diagram of a further exemplary embodiment of a device for plasma-induced water purification according to the second aspect of the invention;

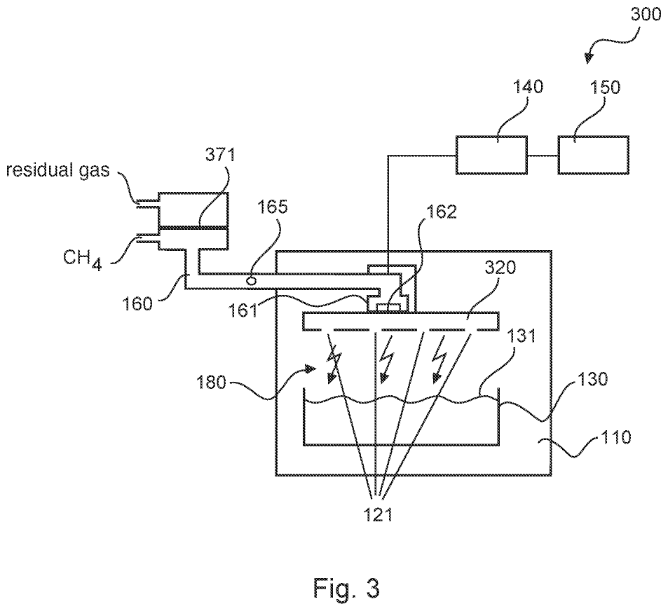

FIG. 3 shows a schematic diagram of an exemplary embodiment of a device for plasma-induced methane production according to the fourth aspect of the invention;

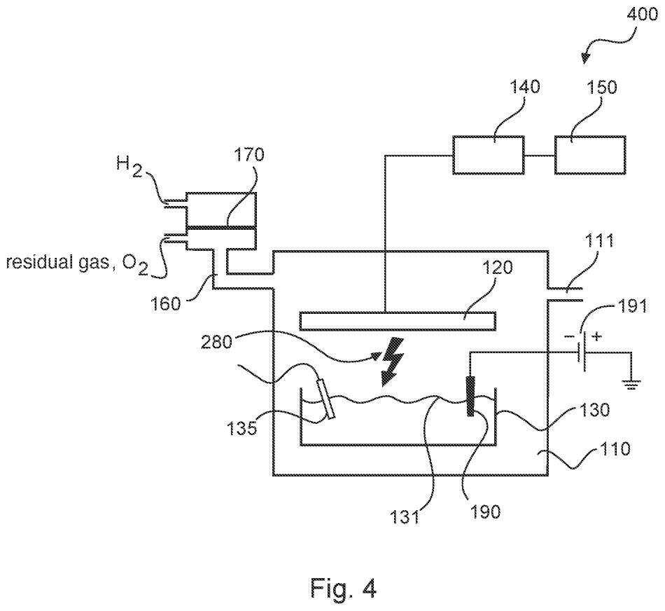

FIG. 4 shows a schematic diagram of a further exemplary embodiment of a device for plasma-induced water purification according to the second aspect of the invention.

FIG. 1 shows an embodiment of a device 100 for plasma-induced purification of water contaminated with at least one wastewater substance, in this case exhaust vapor water, comprising, in a reaction chamber 110, an ungrounded water reservoir 130 as well as at least one flat cooled plasma electrode 120 arranged at a predefined distance, in the depicted exemplary embodiment 1 cm above a fill level 131 of the water reservoir 130. A sensor 135 for measuring the concentration of the at least one wastewater substance, in this case ammonium, is disposed in the water. A common exhaust pipe 160 for hydrogen and oxygen is arranged on the reaction chamber 110. A high-frequency generator 150 is arranged outside of the reaction chamber 110 and connected to the plasma electrode 120 via a matching network 140 for impedance matching of an impedance of the plasma 180 forming at the plasma electrode 120, and of the output impedance of the high-frequency generator. In the embodiment shown, the matching network 140 comprises a motor-controlled capacitor and a variable coil as an electrical oscillating circuit. The matching network is designed to adjust the impedance of the plasma which, in the process, is in particular dependent upon a distance of the plasma electrode 120 to the water surface, a water composition, a temperature in the reaction chamber as well as an atmosphere in the reaction chamber, and the output impedance of the high-frequency generator 150. The output impedance of the high-frequency generator 150 is advantageously 50 ohms. There is atmospheric pressure in the reaction chamber, just like in the surrounding area. The formation of a planar plasma between the plasma electrode 120 and the surface of the water in the water reservoir 130 under atmospheric pressure is possible here because only precisely one electrode, namely the plasma electrode 120, is utilized and, as a counterpart, the water itself is used. To produce the plasma 180, a high-frequency alternating voltage, which the high-frequency generator 150 provides, is applied to the plasma electrode 120. In the embodiment shown, this high-frequency alternating voltage has a frequency in the range of 10 to 20 MHz. Power in the range of 1 bis 40 kW is applied to the plasma electrode here. The dissociation reactions of the water and the wastewater substances occur in a plasma-chemical gas and water volume process. Individual bonds of the wastewater substances are separated under the influence of the plasma, which causes the compound partners to be released and to then react to form e.g. gaseous hydrogen, gaseous oxygen, gaseous nitrogen. This way, on the one hand, the water is purified effectively and, on the other hand, desired byproducts, like hydrogen, are released. The discharges in the gas and water volume as well as on the water surface lead to the generation of free electrons in an energy range that is favorable for the dissociation of water and the wastewater substances. Impacts with the water and gas molecules lead to the formation of numerous excited molecule and atom species. Dissociation takes place via a dual-impact reaction and an extreme charge displacement between the electrode and the water. With its excess of electrons, the plasma acts as a “reducing agent”.

The application of plasma continues until the concentration of the wastewater substance falls below a predefined threshold value and the purified water is thus ready to be reused.

In the exemplary embodiment shown, the plasma electrode 120 has a metallic base, in this case made of aluminum, that is coated with a dielectric, in this case aluminum oxide. The planar plasma 180 is thus formed as a result of a barrier discharge.

A membrane 170 for separating hydrogen from the residual gas is arranged in the common exhaust pipe 160. These can subsequently be collected separately and stored.

In addition, an inlet 111 for introducing at least one gas into the reaction chamber, in this case air, Ar, He, CO, CO₂ and/or Ne, is arranged on the reaction chamber 110. These gases are used especially as an atmosphere in the reaction chamber during the startup process, i.e. when igniting the plasma 180.

The contaminated water in the water reservoir preferably has a temperature in the range of 5 to 25° C. This temperature range promotes the formation of a contracted plasma not shown here). Contracted plasma results in an improved purification capacity. However, it is also possible to use the filamented mode shown here.

FIG. 2 shows a further exemplary embodiment of a device 200 for plasma-induced water purification according to the second aspect of the invention. The device 200 largely corresponds to the device 100 from FIG. 1, which is why only the differences are described below; apart from that, reference is made to the description of FIG. 1. In contrast to the flat single electrode shown in FIG. 1, an electrode arrangement with three flat single electrodes 120a, 120b, 120c, which together make up the plasma electrode, is set up in FIG. 2. All single electrodes are interconnected, and connected to the high-frequency generator 150 via the matching network 140. In the depicted exemplary embodiment, wastewater with carbon compounds is used as the wastewater substance. For this reason, a membrane 171 is arranged in the common exhaust pipe 160; this membrane separates methane from the gas mixture. In addition, an adsorber 172 is arranged for adsorbing oxygen. This means that only hydrogen and possibly other residual gases remain in the exhaust gas mixture. These can be separated by additional membranes or adsorbers.

FIG. 3 shows an exemplary embodiment of a device 300 for producing methane from water polluted with at least one wastewater substance according to the fourth aspect of the invention. The device 300 largely corresponds to the device 100 from FIG. 1, which is why only the differences are described below; apart from that, reference is made to the description of FIG. 1. In contrast to the device in FIG. 1, in the embodiment shown here, a sensor for measuring the concentration of a wastewater substance is not provided, but instead a sensor 165 for measuring a concentration of methane in the exhaust pipe 160. In addition, the plasma electrode 320 is designed in such a way in this case that the exhaust pipe 160 runs through it. The plasma electrode has openings 121 through which the gases that form enter the exhaust pipe, in addition, in the plasma electrode 320, a catalyst chamber 161 with a catalyst 162 in the form of granulate is arranged in the exhaust pipe 160 for methanation of carbon. At the end of the exhaust pipe, methane is separated from the residual gas by a membrane 371. In this arrangement, the focus is on the extraction of methane from water contaminated with carbon compounds; the basic structure corresponds to that of a device for water purification. If carbon compounds in the wastewater substances are dissociated as part of the plasma process, carbon is released that initially reacts to form carbon monoxide or carbon dioxide, for example with oxygen from the latent water dissociation or other dissociation reactions. Once a sufficient quantity of carbon monoxide and/or carbon dioxide is available, a reaction, supported by the plasma, takes place with the hydrogen also available in least from the latent water dissociation to form methane. This reaction is intensified by the catalyst used. For the production of methane, it is preferable to purify water that also contains ammonium so that larger quantities of hydrogen are released than through water dissociation.

FIG. 4 shows a further exemplary embodiment of a device 400 for plasma-induced water purification according to the second aspect of the invention. The device 400 largely corresponds to the device 100 from FIG. 1, which is why only the differences are described below; apart from that, reference is made to the description of FIG. 1. In the device 400, an electrode 190 is arranged in the water reservoir 130 and connected to the negative pole of a direct-voltage source 191. The direct voltage connected to the water reservoir in this manner works similarly to an offset voltage and results in a contracted plasma 280, here symbolized by a broad flash, and thus improved purification capacity. A low direct current is generated in the contaminated water in the process, which only flows across the plasma of the electrode.

### List of Reference Numbers

100, 200, 300, 400 device

110 reaction chamber

111 inlet for at least one gas

120, 320 plasma electrode

120a, 120b, 120c, single electrode

121 opening

130 water reservoir

131 fill level

135 sensor for concentration of wastewater substance

140 matching network

150 high-frequency generator

160 exhaust pipe

161 catalyst chamber

162 catalyst

165 sensor

170, 371 membrane

171 additional membrane

172 adsorber

180 plasma

190 electrode

191 direct voltage source

280 contracted plasma

1. Method of purifying wastewater contaminated with at least one wastewater substance, wherein the wastewater substance has at least one compound with a binding energy that is lower than the binding energy of a simple hydrogen-oxygen bond, comprising the steps:
providing the contaminated water to a predefined fill level of a reaction chamber within an ungrounded water reservoir;
applying a high-frequency alternating voltage at atmospheric pressure to flat cooled plasma electrode arranged at a predefined distance above the wastewater at the predetermined fill level so that a plasma forms in the high-frequency field between the plasma electrode and a surface of the wastewater, the energy input of such plasma being sufficient to cause compounds with a binding energy lower than or equal to that of the simple hydrogen-oxygen bond to be dissociated; and
measuring the concentration of the at least one wastewater substance.

2. Method according to claim 1, wherein the high-frequency alternating voltage is applied to the plasma electrode creating a contracted plasma.

3. Method according to claim 2, wherein a direct voltage is connected to the water reservoir with its negative pole and the direct voltage is preferably in the range of 100 V to 3000 V and 0.01 mA to 250 mA.

4. Method according to claim 1, further comprising:
concentrating the at least one wastewater substance in the contaminated water.

5. Method according to claim 1, wherein the contaminated water is collected in at least one transport container, transported in the transport container, and the contaminated water is then provided in the water reservoir from the transport container.

6. Method according to claim 1, further comprising:
comparing the measured concentration with a stored threshold value, at which the following occurs if the measured concentration is below or equal to the threshold value:
the application is stopped, or
the treated water is drained and replaced with contaminated water.

7. Method according to claim 1, wherein the at least one wastewater substance is a nitrogen, carbon, boron, oxygen, phosphorus, sulfur, or chlorine compounds.

8. Method according to claim 1, wherein a high-frequency generator with a predefined output impedance is used to apply the high-frequency alternating voltage to the plasma electrode; this high-frequency generator connected to the plasma electrode via a matching network for impedance matching of an impedance of the plasma and of the output impedance of the high-frequency generator.

9. Method according to claim 8, wherein the intensity and power of an outgoing and returning wave to the high-frequency generator is measured, and the generator power is stabilized depending on the power of the outgoing wave, and the power of the returning wave is minimized depending on a conductivity of the contaminated water by means of the matching network.

10. Method according to claim 6, wherein the stored threshold value is a statutory limit or below a statutory limit.

11. Method according to claim 1, further comprising:
collecting gases generated as a result of the dissociation in a common exhaust pipe in gas communication with the reaction chamber; and
separating the generated gases by way of a multi-stage membrane process and/or by using selective adsorption methods.

12. Method according to claim 1, wherein the contaminated water includes at least one nitrogen compound containing at least one nitrogen-hydrogen bond and at least one carbon compound as the wastewater substances, and further comprising:
collecting gases generated as a result of the dissociation in a common exhaust pipe;
measuring a methane concentration in the common exhaust pipe;
maintaining the application until a minimum methane concentration in the exhaust pipe is reached.

13. Method according to claim 12, wherein a catalyst is used for the methanation of carbon monoxide and/or carbon dioxide.

14. Device for purification of water contaminated with at least one wastewater substance, comprising:
a reaction chamber
disposed within an ungrounded water reservoir;
a flat cooled plasma electrode that is arranged at a predefined distance above a predetermined fill level of the reaction chamber;
a sensor for measuring the concentration of the wastewater substance;
a high-frequency generator with a predefined output impedance that is connected to the plasma electrode via a matching network for impedance matching of an impedance of the plasma forming at the plasma electrode, and of the output impedance of the high-frequency generator disposed outside of the reaction chamber.

15. Device according to claim 14, further comprising a direct current source connected to the water reservoir with its negative pole via an electrode.

16. Device according to claim 14, wherein the high-frequency generator comprises a measuring device for measuring the intensity and power of an outgoing and returning wave.

17. Device according to claim 14, wherein the plasma electrode is coated with a dielectric and the plasma is designed as a barrier discharge.

18. Device according to claim 14, wherein the plasma electrode comprises several individual electrodes arranged next to each other at a predefined distance above the fill level.

19. Device according to claim 14, wherein the water reservoir has an inlet and at least one outlet, and the sensor is arranged in the area of the at least one outlet.

20. Device according to claim 14, wherein the water reservoir comprises a fill-level control that is designed to keep the fill level of the water nearly constant, or an overflow.

21. The device of claim 13, wherein only a single plasma electrode is provided.
